(19) United States
(12) Patent Application Publication
(10) Pub. No.: US 2023/0346161 A1
(43) Pub. Date: Nov. 2, 2023

(54) Novel Roasting Pan with Temperature Probe

(71) Applicant: Quan Trinh, San Jose, CA (US)

(72) Inventor: Quan Trinh, San Jose, CA (US)

(21) Appl. No.: 17/733,572

(22) Filed: Apr. 29, 2022

(51) Int. Cl. A47J 37/06; A47J 36/06

(52) U.S. Cl. CPC A47J 37/067; A47J 36/06; A47J 2202/00

(57) ABSTRACT

The present invention is a novel roasting pan system whereby a meat probe is configured for inserting into any product placed within the roasting pan and the temperature reading is read on the outside of the pan.

### BACKGROUND OF THE INVENTION

The skill and artistry of the culinary arts is more well-known now than has ever been in history. Media personalities have introduced the world to the find skills that for many years have been hidden in the kitchen. The skilled culinary artisan is forever seeking new and effective tools in order to produce their creations. An ever-present device is the meat thermometer. As most people understand, individual tastes from rare, medium, and well done, or often requested of the culinary artist.

While the meat thermometer is an important tool in determining the internal temperature of a meat product, there still is one significant drawback to its use.

When the culinary artist is preparing a meat dish inside a roasting pan, it is often difficult to determine the internal meat temperature during the cooking process. There is a need for a way to read internal meat temperature of a meat product inside a roasting pan without removing the pan from the oven and/or the pan cover.

The present invention addresses this issue.

### SUMMARY OF THE INVENTION

In one embodiment, the present invention is a roasting pan system comprising:
a main roasting pan body;
a main roasting pan body cover;
a meat temperature probe configured for inserting into meat positioned in said main roasting pan body and measuring internal cooking temperature during cooking;
a visual display operatively associated with said meat temperature probe, whereby said visual display is positioned for viewing from outside said main roasting pan body.

In one embodiment, the visual display is attached to said main roasting pan body cover.

In one embodiment, the visual display is a digital display.

In one embodiment, the visual display is an analog display.

One embodiment of the invention is a roasting pan system comprising:
a main roasting pan body;
a main roasting pan body cover;
a meat temperature probe configured for inserting into meat positioned in said main roasting pan body and measuring internal cooking temperature during cooking;
an ambient temperature probe positioned interiorly in said main roasting pan body configured for measuring ambient temperature in said main roasting pan body during cooking; a meat temperature probe visual display operatively associated with said meat temperature probe, whereby said visual display is positioned for viewing from outside said main roasting pan body; and
an ambient temperature probe visual display operatively associated with said ambient temperature probe, whereby said visual display is positioned for viewing from outside said main roasting pan body.

In one embodiment, the each of said meat temperature probe visual display and ambient temperature probe visual display are attached to said main roasting pan body cover.

In one embodiment, the each of said meat temperature probe visual display and ambient temperature probe visual display are digital displays.

In one embodiment, the each of said meat temperature probe visual display and ambient temperature probe visual display are analog displays.

In one embodiment, the present invention is a roasting pan system consisting of:
a main roasting pan body;
a main roasting pan body cover;
a meat temperature probe configured for inserting into meat positioned in said main roasting pan body and measuring internal cooking temperature during cooking;
a visual display operatively associated with said meat temperature probe, whereby said visual display is positioned for viewing from outside said main roasting pan body, wherein the visual display is attached to said main roasting pan body cover.

One embodiment of the invention is a roasting pan system consisting of:
a main roasting pan body;
a main roasting pan body cover;
a meat temperature probe configured for inserting into meat positioned in said main roasting pan body and measuring internal cooking temperature during cooking;
an ambient temperature probe positioned interiorly in said main roasting pan body configured for measuring ambient temperature in said main roasting pan body during cooking; a meat temperature probe visual display operatively associated with said meat temperature probe, whereby said visual display is positioned for viewing from outside said main roasting pan body; and
an ambient temperature probe visual display operatively associated with said ambient temperature probe, whereby said visual display is positioned for viewing from outside said main roasting pan body, whereby each of said meat temperature probe visual display and ambient temperature probe visual display are attached to said main roasting pan body cover.

### BRIEF DESCRIPTION OF THE SEVERAL VIEWS OF THE DRAWINGS

FIG. 1 is a perspective view of one embodiment of the present invention utilizing a single thermometer probe.

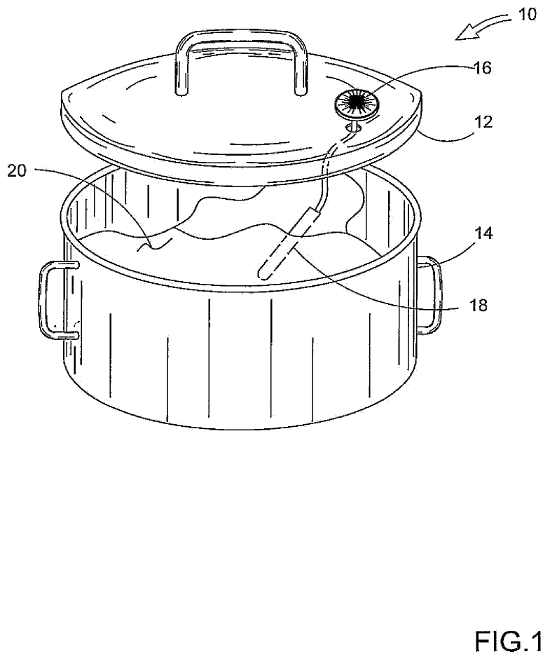

FIG. 2 is a perspective view of one embodiment of the present invention utilizing a two separate thermometer probes.

### DETAILED DESCRIPTION OF THE PREFERRED EMBODIMENTS

The present invention is a roasting pan configured with a thermometer system incorporated there with.

Roasting pan system 10 includes a main roasting pan 14 and a roasting pan cover 12. It should be noted and understood that although the drying figure demonstrates a round roasting pan, the present invention is not limited to any particular shape. Meat temperature probe 18 is inserted into meat 20 in a manner commonly understood such that meat temperature probe 18 will be able to properly determine the internal temperature of meat 20. The probe 18 is typically inserted into the meat before starting cooking, and cooking continued until the desired internal temperature is reached. The tip of the probe should be in the thickest part of the meat, but not touching bone, which conducts heat and gives an overestimate of the meat temperature.

Meat temperature probe 18 is operatively connected to a meat temperature gauge 16 whereby meat temperature gauge 16 is positioned such that the temperature reading provided by meat temperature probe 18 is readable outside roasting pan system 10 and does not require a user to remove roasting pan system 10 or to remove roasting pan cover 12. A user can merely look at meat temperature gauge 16 and be provided with the internal temperature of meat 20 as read by meat temperature probe 18.

As generally known and understood, internal meat temperatures include:
Poultry—165° F.
Beef, lamb and veal—ranging from 145° F. for medium-rare to 170° for well done
Pork—160° F.
Ground meat ranging from 160° F.-165° F.

As understood, meat temperature gauge 16 is configured with visual indicia, analog and/or digital, to read in the range including these temperatures. Typically, the indicia range on meat temperature gauge 16 is from 0-250° F. In one embodiment, the indicia range on meat temperature gauge 16 is from 0-300° F.

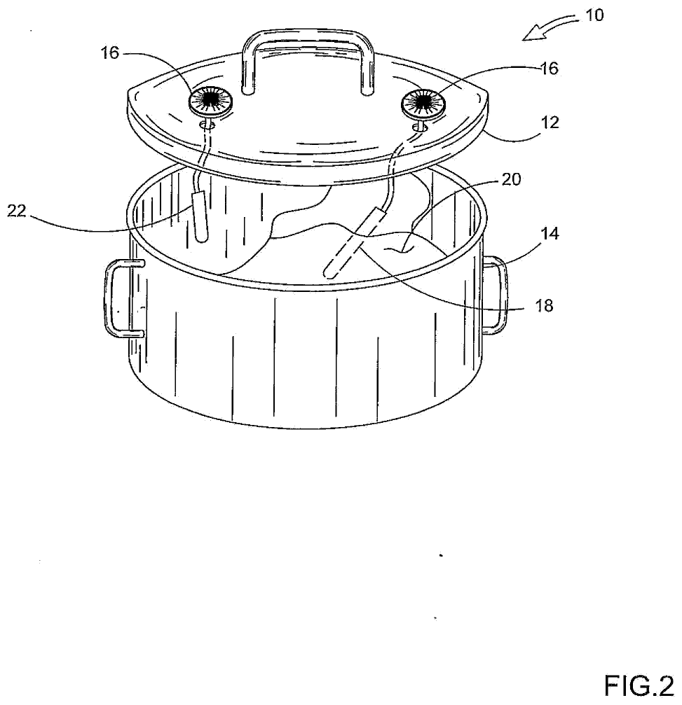

In an additional embodiment, as demonstrated in FIG. 2, system is configured with two separate temperature probes. Meat temperature gauge 16 as previously disclosed is presented with ambient temperature probe 22. In this embodiment, the skilled culinary artisan is able to monitor separately the internal temperature of meat 20 along with the ambient air temperature inside roasting pan 14. Ambient temperature gauge 24 is configured with visual indicia, analog and/or digital, to read in the range of 0-550° F.

In providing this configuration with two separate temperature probes, the culinary artisan monitors internal temperature within interior of pan 14 for those instances when significant control of cooking temperature is desired.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A roasting pan system comprising:
a main roasting pan body;
a main roasting pan body cover;
a meat temperature probe configured for inserting into meat positioned in said main roasting pan body and measuring internal cooking temperature during cooking;
a visual display operatively associated with said meat temperature probe, whereby said visual display is positioned for viewing from outside said main roasting pan body.

2. The system of claim 1 wherein said visual display is attached to said main roasting pan body cover.

3. The system of claim 1 wherein said visual display is a digital display.

4. The system of claim 1 wherein said visual display is an analog display.

5. A roasting pan system comprising:
a main roasting pan body;
a main roasting pan body cover;
a meat temperature probe configured for inserting into meat positioned in said main roasting pan body and measuring internal cooking temperature during cooking;
an ambient temperature probe positioned interiorly in said main roasting pan body configured for measuring ambient temperature in said main roasting pan body during cooking;
a meat temperature probe visual display operatively associated with said meat temperature probe, whereby said visual display is positioned for viewing from outside said main roasting pan body; and
an ambient temperature probe visual display operatively associated with said ambient temperature probe, whereby said visual display is positioned for viewing from outside said main roasting pan body.

6. The system of claim 5 wherein each of said meat temperature probe visual display and ambient temperature probe visual display are attached to said main roasting pan body cover.

7. The system of claim 5 wherein each of said meat temperature probe visual display and ambient temperature probe visual display are digital displays.

8. The system of claim 5 wherein each of said meat temperature probe visual display and ambient temperature probe visual display are analog displays.
